(19) United States
(12) Patent Application Publication
(10) Pub. No.: US 2025/0334175 A1
(43) Pub. Date: Oct. 30, 2025

(54) EAXLE WITH HOUSING COVER HAVING INTEGRATED LUBRICATION SYSTEM COMPONENTS AND PREASSEMBLED HOUSING COVER

(71) Applicant: Schaeffler Technologies AG & Co. KG, Herzogenaurach (DE)

(72) Inventor: Evan Blitz, Massillon, OH (US)

(73) Assignee: Schaeffler Technologies AG & Co. KG, Herzogenaurach (DE)

(21) Appl. No.: 18/647,035

(22) Filed: Apr. 26, 2024

(51) Int. Cl. F16H 57/04; F16H 57/02; F16H 57/021; F16H 57/031; F16H 57/032

(52) U.S. Cl. CPC F16H 57/0476; F16H 57/031; F16H 57/032; F16H 57/0424; F16H 2057/02034; F16H 2057/02052; F16H 57/021; F16H 57/0404; F16H 57/0415

(57) ABSTRACT

A cover assembly for an electric axle assembly is provided, with the electric axle assembly having a casing with a stator, a rotor and gears for the electric axle assembly therein. The cover assembly includes a housing that is adapted to close an open end of the electric axle casing. The housing includes a first bearing support for a bearing of the rotor, an oil pump mount connected to at least one oil passage at least partially defined in the housing, and a filter mount in communication with the at least one oil passage. An oil pump is fluidly connected to the oil pump mount, and an oil filter connected to the filter mount. The cover assembly is a preassembled sub-assembly that can be installed as one piece on the electric axle assembly. An electric axle assembly is also provided.

### TECHNICAL FIELD

The disclosure relates to electric axles (eAxles) for motor vehicles having an oil supply for lubrication and cooling.

### BACKGROUND

In general, eAxles are known structures used in electric vehicles. eAxles typically include an electric motor and power transmission components for transmitting torque from the electric motor to the wheels of the vehicle. The power transmission components can include one or more gear stages and a differential. Differentials typically rely on passive lubrication from the differential components being partially submerged in oil. Rotation of the partially submerged differential components slings oil to other areas of the differential ensuring proper lubrication and cooling.

Due to the presence of the electric motor in the eAxle, lubrication has to be carefully controlled. The presence of oil in the air gap of the electric motor can reduce efficiency due to churning losses. Further, oil has to be sprayed on the stator for cooling in addition to the lubrication function for the gear stages.

There is also limited space in the eAxle casing (or housing) for the lubrication and cooling components, which may include a pump, one or more filters, and a heat exchanger. Further, passages in the eAxle housing either require specific casting of or machining on or in the e-axle housing, or the addition of separate tubes that had to be installed, along with other lubrication system components, which must be installed on the eAxle housing during assembly. There are also constant demands by vehicle manufacturers for reducing the envelope for the overall eAxle, as well as a desire to improve quality and reduce costs.

It would be desirable to provide an arrangement for oil lubrication and cooling components of an e-axle that reduces the space requirements in the eAxle housing and further simplifies assembly.

### SUMMARY

In one aspect, a cover assembly is provided for an electric axle assembly, with the electric axle assembly having an eAxle casing with a stator, a rotor and gears for the electric axle assembly therein. The cover assembly includes a housing that is adapted to close an open end of the eAxle casing. The housing includes a first bearing support for a bearing of the rotor, an oil pump mount connected to and in fluid communication with at least one oil passage at least partially defined in the housing, and a filter mount in fluid communication with the at least one oil passage. An oil pump is connected to the oil pump mount, and an oil filter is connected to the filter mount.

In one embodiment, an oil cooler mount is formed on the housing, an oil cooler is connected to the oil cooler mount, and the at least one oil passage defined at least partially in the housing extends to and is in fluid communication with the oil cooler mount in order to deliver oil to or receive oil from the oil cooler.

The cover assembly is pre-assembled, including the housing, the oil pump, and the oil cooler prior to being assembled with the electric axle casing. In this manner, the ability for better space utilization within the electric axle casing is provided, in order to conform to a specific space envelope. Further, having the cover assembly pre-assembled with the oil pump and other cooling/lubrication circuit components allows for more efficient assembly and testing of these components in a sub-assembly stage, resulting in easier assembly and higher quality of the overall electric axle assembly.

In one aspect, the cover assembly may include at least one cover connected to the housing that closes off an open side of at least a portion of the at least one oil passage. The at least one passage may include two or more oil passages and there may be two or more covers which are assembled to the housing on a side that faces, and upon assembly with the electric axle casing, defines an interior wall of the lubrication cavity within the eAxle casing.

In another aspect, a port can be formed in the housing in a region of a contact surface with the eAxle casing that is adapted to deliver oil from the oil pump to the eAxle casing. This feeds oil for cooling and/or lubrication of the stator and gears within the eAxle casing.

In one embodiment, a sump intake is connected to the oil pump. The sump intake is adapted to extend into the electric axle casing to draw oil from the sump area for circulation by the pump through the filter and optionally the oil cooler, prior to redistributing the oil through the at least one passage for cooling and/or lubrication purposes. A prefilter can be attached to the sump intake.

In one embodiment, the housing is a cast aluminum housing and the at least one oil passage is at least partially formed in the cast aluminum housing. However, the housing could be made of other suitable materials, including plastics or composites, and could be formed by other methods, such as machining.

In one particular embodiment, the housing includes a second bearing support for a gear. This can be for a speed reduction gear and/or as part of the offset gear that delivers torque from the electric motor to the differential. The gear may be supported by at least one shaft that is rotatably supported by the bearing

As part of the assembly, a bearing is located in the first bearing support or bearings are located in the first and second bearing supports if both are present. Depending on the application, the bearing(s) may be pre-assembled with the housing assembly. Alternatively, they can be installed as part of the overall assembly of the eAxle.

In one embodiment, an oil spray tube is mounted to the housing and is fluidly connected to the to at least one oil passage and adapted to extend into the eAxle casing. The oil spray tube can spray oil on the stator for cooling.

In another aspect, an electric axle assembly is provided that includes an eAxle casing having a stator, a rotor and gears therein, with the eAxle casing having at least one open end. A cover assembly is provided that closes the open end of the eAxle casing. The cover assembly includes a housing with a first bearing support for a bearing of the rotor, an oil pump mount connected to and in fluid communication with at least one oil passage at least partially defined in the housing, and a filter mount in fluid communication with the at least one oil passage. An oil pump is connected to the oil pump mount, and an oil filter is connected to the filter mount. The cover assembly is preassembled prior to being attached to the eAxle casing. This provides the benefits noted above.

In one embodiment, an oil cooler mount is formed on the housing, an oil cooler is connected to the oil cooler mount, and the at least one oil passage defined at least partially in the housing extends to and is in fluid communication with the oil cooler mount. Here, the oil cooler is preassembled with the cover assembly prior to being attached to the electric axle casing.

In one embodiment, at least one cover is connected to the housing on a side facing the eAxle casing that closes off an open side of at least a portion of the at least one oil passage.

In one embodiment, a port is formed in the housing in a region of a contact surface with the eAxle casing that is in fluid communication with a port in the eAxle casing to deliver oil from the oil pump to the electric axle casing.

In one embodiment, a sump intake is fluidly connected to the oil pump, and the sump intake extends into the electric axle casing.

The housing and the electric axle casting may be made as cast aluminum parts, and the at least one oil passage is at least partially formed in the cast aluminum housing. Other materials and suitable manufacturing methods could be used.

In one embodiment, the housing includes a second bearing support for a gear that is located in the electric axle casing. The gear can be part of a speed reduction gear or an offset gear that delivers torque from the electric motor to the differential.

In one embodiment, bearings are located in the first and second bearing supports.

In one embodiment, an oil spray tube is connected to the to at least one oil passage and extends into the electric axle casing to spray oil for lubrication and/or cooling.

One or more of the above features can be combined to provide a gear assembly with improved performance.

### BRIEF DESCRIPTION OF THE DRAWING(S)

The foregoing Summary as well as the following Detailed Description will be best understood when read in conjunction with the appended drawings, which illustrate an embodiment according to the disclosure. In the drawings:

FIG. 1 is a block diagram that functionally represents the electric axle assembly

having a cover assembly in accordance with the present disclosure.

FIG. 2 is a top view of an embodiment of an electric axle assembly having a cover assembly that includes oil lubrication and cooling components in accordance with the present disclosure.

FIG. 3 is an end view of the electric axle assembly with the cover assembly shown in FIG. 2.

FIG. 4 is an enlarged perspective view of the cover assembly having a housing which is shown with the oil pump, oil filter as well as the oil cooler preassembled with the housing.

FIG. 5 is an elevational view of the outside part of the housing shown in FIG. 4.

FIG. 6 is a side view of the housing shown in FIG. 4 with portions of the electric axle assembly including the eAxle casing, stator, rotor, and bearings being schematically represented.

FIG. 7 is an elevational view showing the inside of the cover assembly shown in FIGS. 4-6.

### DETAILED DESCRIPTION

Certain terminology is used in the following description for convenience only and is not limiting. “Axial” refers to a direction along an axis. A reference to a list of items that are cited as “at least one of a, b, or c” (where a, b, and c represent the items being listed) means any single one of the items a, b, or c, or combinations thereof. The terms “generally”, “about” and “approximately” are to be construed as within 10% of a stated value or ratio. The terminology includes the words specifically noted above, derivatives thereof, and words of similar import.

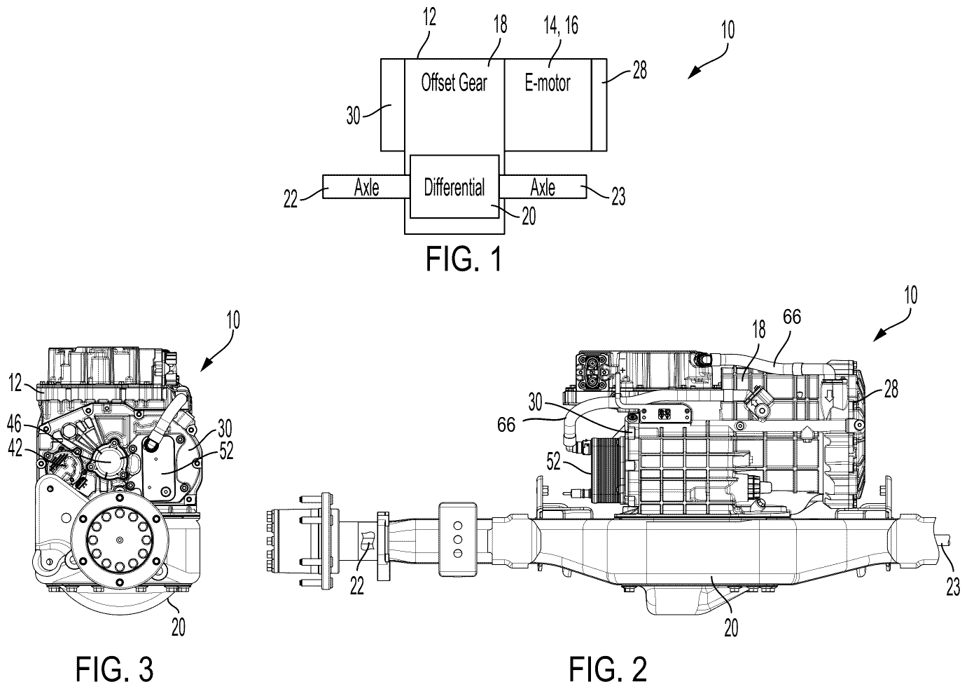

Referring to FIG. 1, a schematic diagram of an electric axle assembly 10 (“eAxle 10”) is shown. The eAxle 10 includes an eAxle casing 12 with a stator 14, a rotor 16 (both represented by the “E-Motor”) as well as gears 18 located therein. The gears 18 may include a reduction gear, offset gearing and/or the differential 20 which transfers torque to the axles 22, 23. The eAxle casing 12 could also be a separate part from and bolted to the differential casing (not separately labeled). Hubs (not shown in FIG. 1) are connected to ends of the axles 22, 23 in order to transfer torque to the wheels mounted on the hubs for driving a vehicle. The diagram in FIG. 1 is schematic only and the specific components can be arranged in various other configurations. The envelope occupied by the eAxle casing 12 is typically limited by vehicle manufactures and space for components of the eAxle assembly is at a premium. To avoid the challenges with assembly of the e-motor with oil lubrication and cooling components during construction of the eAxle assembly 10, the cover assembly 30 as described in detail below is provided.

Referring to FIGS. 2 and 3, an embodiment of an eAxle assembly 10 is shown in more detail and includes the eAxle casing 12 shown connected to a differential 20 from which the axles 22, 23 extend is shown, with the axle 22 and hub shown on one side and the axle 23 on the other side being broken away. This represents one configuration of an eAxle assembly 10. However, those skilled in the art will recognize that other configurations can be provided, depending upon the specific space envelope available for the eAxle casing 12. As shown, the cover assembly 30 for the eAxle assembly 10 is located on one side in order to allow access for assembling the stator 14 and rotor 16 to form the e-motor within the eAxle casing 12 along with any gears 18 as well as support shafts, etc., as will be understood of ordinary skill in the art based on the present disclosure. The eAxle casing 12 can also include a removable cover plate 28 on the other side.

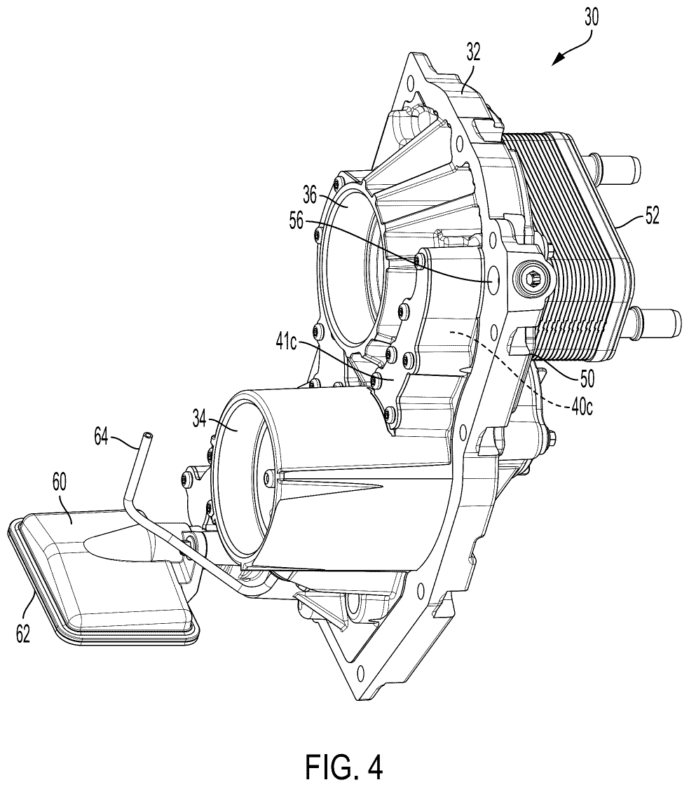

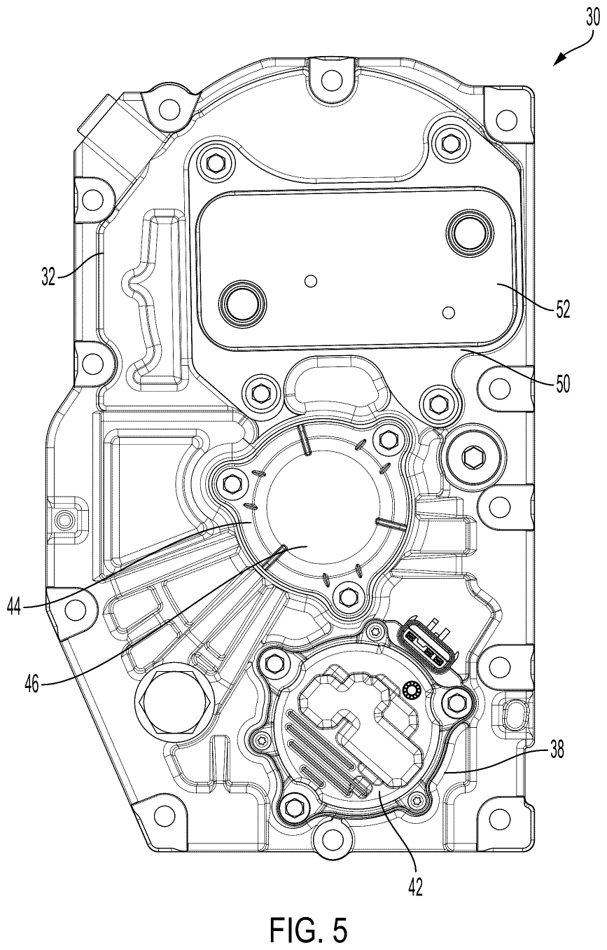

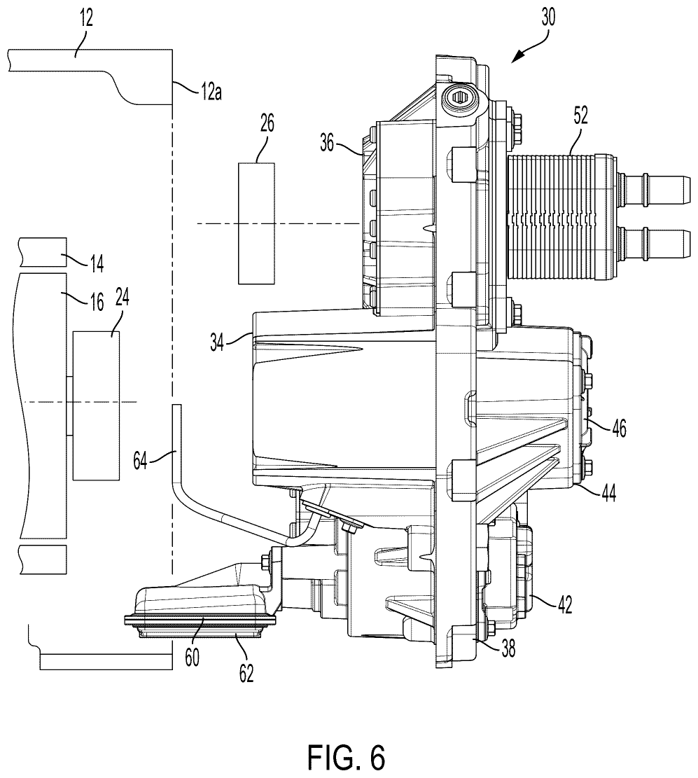

As shown in detail in FIGS. 4-7, the cover assembly 30 preferably includes a housing 32, which may be a cast aluminum housing. However, the housing 32 could be made of other suitable materials, and can be manufactured using different methods. The housing 32 is adapted to close an open end 12a (indicated in FIG. 6) of the eAxle casing 12. The housing 32 also includes a first bearing support 34 for a first bearing 24 that can be used to support the rotor 16 of the e-motor. The housing 32 further includes an oil pump mount 38 connected to at least one oil passage 40a, 40b, 40c that is at least partially defined in the housing 32. The at least one oil passage 40a, 40b, 40c may be formed partially in the cast aluminum housing, or can be fully formed therein, for example using removable cores or via lost core molding. Alternatively, the at least one passage 40a, 40b, 40c is only partially formed in the housing 32 and at least one cover 41a, 41b, 41c is connected to the housing 32 and closes off an open side of at least a portion of the at least oil passage 40a, 40b, 40c. In the illustrated embodiment, there are at least three of the oil passages 40a, 40b, 40c and three covers 41a, 41b, 41c are provided. However, the number of oil passages and covers may be varied depending upon the particular arrangement and application. The covers 41a, 41b, 41c are located on a side of the housing 32 that faces the eAxle casing 12 and forms an internal wall of the cavity within the eAxle casing 12 when assembled. Accordingly, the covers 41a, 41b, 41c do not need to be sealed to the housing 32, and separate seals are not required as any “leakage” is within the internal cavity.

Still with reference to FIGS. 4-7, a filter mount 44 is provided in fluid communication with the at least oil passage 40a, 40b, 40c. The filter mount 44 may be of a known type and include threads for receiving a cartridge-type oil filter.

An oil pump 42 is connected to the oil pump mount 38, and an oil filter 46 is connected to the filter mount 44 such that oil fed through the at least one oil passage 40a, 40b, 40c via the oil pump 42 is filtered by a filter 46 attached to the filter mount 44.

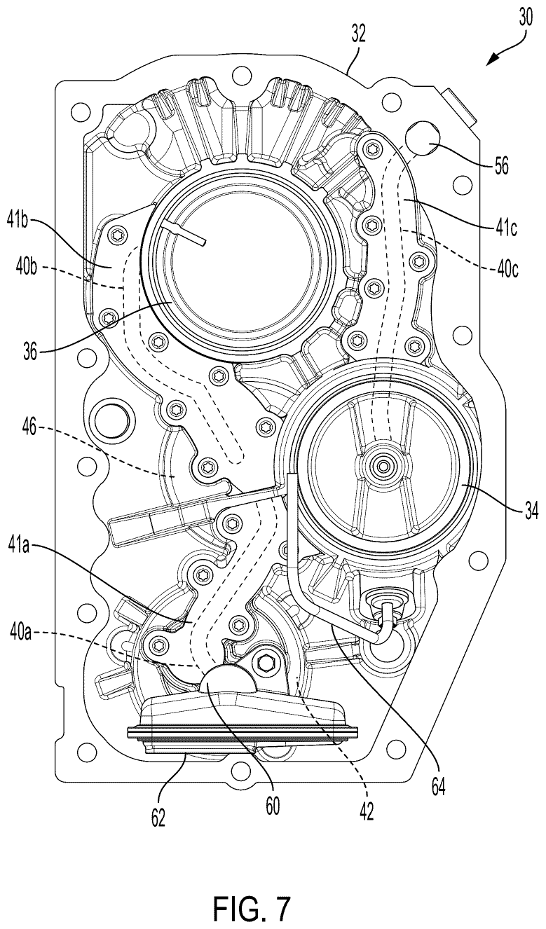

As shown in FIGS. 4-6, in the illustrated arrangement, an oil cooler mount 50 is formed on the housing 32. Here, an oil cooler 52 is connected to the oil cooler mount 50 and is in fluid communication with the at least one oil passage 40a, 40b, 40c defined at least partially in the housing 32. As shown in FIG. 7, at least one of the oil passages 40c extends to the oil cooler mount 50 in order to circulate oil used for both lubrication and cooling within the eAxle assembly 10 to and/or from the oil cooler 52 for cooling.

In accordance with the present disclosure, the cover assembly 30 is pre-assembled, including the housing 32, the oil pump 42, and the oil cooler 52 prior to being assembled with the eAxle casing 12. This allows these components to be separately assembled and tested which not only improves quality but reduces assembly time for the overall eAxle assembly 10.

As shown in FIG. 7, a port 56 may be formed in the housing 32 is a region of a contact surface 33 with the eAxle casing 12. This port 56 is adapted to deliver oil from the oil pump 42 to the eAxle casing 12 where it is distributed for lubrication and/or cooling. The port 56 is preferably in fluid communication with the at least one oil passage 40c as shown in FIG. 7.

As shown in detail in FIGS. 4 and 6, the cover assembly 30 may also include a sump intake 60 that is fluidly connected to the oil pump 42. The sump intake 60 may be preassembled with the cover assembly 30 and is adapted to extend into a sump region of the internal cavity within the eAxle casing 12. A pre-filter 62 can be provided on the sump intake 60

In the illustrated embodiment of the eAxle assembly 10 with the cover assembly 30, the cover assembly 30 also includes a second bearing support 36, which is adapted to support a gear, such as the offset gear 18 or a reduction gear via a shaft (not shown) which is received and supported in a second bearing 26, illustrated in FIG. 6, that can be received in the second bearing support 36. The bearings 24, 26 may be preassembled in the first and second bearing supports 34, 36 or these may be inserted as part of the installation of the cover assembly 30 on the eAxle casing 12.

Referring again to FIG. 6, an oil spray tube 64 may be fluidly connected to the at least one oil passage 40a, 40b, 40c and is adapted to extend into the eAxle casing 12. The oil spray tube 64 is adapted to spray oil pumped via the oil pump 42 for cooling and/or lubrication on to the stator 14 and/or gearing located within the eAxle casing 12.

The housing 32 can be cast from aluminum or any other suitable metal, as noted above. However, it could also be a machined part and/or formed at least in part of a composite material, depending upon the particular application.

According to the disclosure, the eAxle assembly 10 as shown in FIGS. 1-3 can also be provided including the axle casing 12, the stator 14, the rotor 16, the gears 18 which can be an offset gear and/or differential 20. The eAxle casing 12 includes the at least one open end 12a, and the cover assembly 30, as described above, is assembled to the eAxle casing 12 as part of the overall assembly 10. As noted above, the cover assembly 30 may be preassembled with the oil pump 42, oil filter 46, oil cooler 50 as well as optionally the sump intake 60. This allows the cover assembly 30 to be provided as a complete sub-assembly rather than having individual components from the oil lubrication and/or cooling system attached to the eAxle casing 12. Fluid communication of the oil from the pump 42 is provided to components within the eAxle casing 12 via the port 56. Other connections between the eAxle casing 12 and the oil lubrication/cooling system provided in the cover assembly 30 may be provided via one or more hoses 66, for example as shown in FIG. 2, that extend between the casing 12 and the cover assembly 30.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein. It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 eAxle
12 eAxle casing
12a open end of eAxle casing
14 stator (of emotor)
16 rotor (of emotor)
18 gears
20 differential
22, 23 axles
24 first bearing
26 second bearing
28 removable cover plate
30 cover assembly
32 housing
34 first bearing support
36 second bearing support
38 oil pump mount
40a, b, c oil passages
41a, b, c covers
42 oil pump
44 filter mount
46 filter
50 oil cooler mount
52 oil cooler
56 port
60 sump intake
62 pre-filter
64 oil spray tube

1. A cover assembly for an electric axle assembly which has an electric axle casing with a stator, a rotor, and gears for the electric axle assembly therein, the cover assembly comprising:
a housing adapted to close an open end of the electric axle casing, the housing including a first bearing support for a bearing of the rotor, an oil pump mount connected to at least one oil passage at least partially defined in the housing, and a filter mount in communication with the at least one oil passage;
an oil pump connected to the oil pump mount;
an oil filter connected to the filter mount; and
a port formed in the housing that is adapted to deliver oil from the oil pump to the electric axle casing, the port extending through a contact surface of the housing which contact surface directly contacts the electric axle casing when assembled.

2. The cover assembly of claim 1, further comprising an oil cooler mount formed on the housing, an oil cooler connected to the oil cooler mount, and the at least one oil passage defined at least partially in the housing extends to the oil cooler mount.

3. (canceled)

4. The cover assembly of claim 1, further comprising at least one cover connected to the housing that closes off an open side of at least a portion of the at least one oil passage.

5. (canceled)

6. The cover assembly of claim 1, further comprising a sump intake connected to the oil pump.

7. The cover assembly of claim 1, wherein the housing is a cast aluminum housing and the at least one oil passage is at least partially formed in the cast aluminum housing.

8. The cover assembly of claim 1, wherein the housing includes a second bearing support for a gear.

9. The cover assembly of claim 8, further comprising bearings located in the first and second bearing supports.

10. The cover assembly of claim 1, further comprising an oil spray tube connected to the at least one oil passage and adapted to extend into the electric axle casing.

11. An electric axle assembly, comprising:
an electric axle casing having a stator, a rotor, and gears disposed fully therein, the electric axle casing having at least one open end;
a cover assembly that closes the open end of the electric axle casing attached to the electric axle casing, the cover assembly including:
a housing with a first bearing support for a bearing of the rotor, an oil pump mount connected to at least one oil passage at least partially defined in the housing, and a filter mount in communication with the at least one oil passage,
an oil pump connected to the oil pump mount; and
an oil filter connected to the filter mount; and
an oil spray tube connected to the to at least one oil passage that extends into the electric axle casing, the oil spray tube being a separate component from the electric axle casing and the cover assembly.

12. The electric axle assembly of claim 11, further comprising an oil cooler mount formed on the housing, an oil cooler connected to the oil cooler mount, and the at least one oil passage defined at least partially in the housing extends to the oil cooler mount.

13. (canceled)

14. The electric axle assembly of claim 11, further comprising at least one cover connected to the housing on a side facing the electric axle casing that closes off an open side of at least a portion of the at least one oil passage.

15. The cover assembly of claim 11, further comprising a port formed in the housing in a region of a contact surface with the electric axle casing that is in fluid communication with a port in the electric axle casing to deliver oil from the oil pump to the electric axle casing.

16. The cover assembly of claim 11, further comprising a sump intake connected to the oil pump, the sump intake extending into the electric axle casing.

17. The cover assembly of claim 11, wherein the housing is a cast aluminum housing and the at least one oil passage is at least partially formed in the cast aluminum housing.

18. The cover assembly of claim 11, wherein the housing includes a second bearing support for a gear that is located in the electric axle casing.

19. The cover assembly of claim 18, further comprising bearings located in the first and second bearing supports.

20. (canceled)

21. (canceled)

22. (canceled)
